(19) United States
(12) Patent Application Publication
(10) Pub. No.: US 2002/0062195 A1
(43) Pub. Date: May 23, 2002

(54) Faulty component detecting system

(75) Inventor: Miki Shingo, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/984,719

(22) Filed: Oct. 31, 2001

(30) Foreign Application Priority Data
Nov. 22, 2000 (JP) 2000-355259

(51) Int. Cl. G01B 5/28; G01B 5/30; G06F 19/00

(52) U.S. Cl. 702/35

(57) ABSTRACT

The system of the invention includes a board 2 mounted with a plurality of electronic components 1 and a controller 3, which has a faulty component detecting function and a hot swap function. Each of the electronic components 1 is mounted on the board 2 with electronic lock means 4A and 4B and also pressing means 5 and the board 2 is further mounted with a nonvolatile memory 6 in which a board-side unlock code is stored, which code is transmitted by the controller 3 to the electronic lock means 4A and 4B. The electronic lock means 4A and 4B are provided with a function to unlock a component if correspondence is detected between a board-side unlock code and a lock means-side unlock code.

### BACKGROUND OF THE INVENTION

1. Field of the Invention

The present invention relates to a faulty component detecting system and, more particularly to, such a faulty component detecting system that has a hot swap function, by which an electronic component can be attached and detached without turning off a computer.

2. Description of the Related Art

Conventionally, a computer system, especially a large-sized computer system has a host swap (hot plug) function, by which technology an interface or an electronic component of a peripheral apparatus can be attached and detached in a state where the power supply of the system is ON. In addition to the hot swap function, it also has a function to automatically detect a failure of a electronic component etc. mounted therein.

And, if a faulty component is detected by such a function, a person in charge of maintenance confirms the faulty component and then replace manually with a new one. Thus, in a large-sized computer such as a server computer required to be continuously operating, its peripheral apparatus such as a hard disk drive can be hot-swapped and is also multiplexed so as to be replaced with a new one upon failure occurrence without halting the system, thus enabling continuous operation of the system.

Such a conventional computer system, however, has the following disadvantage. That is, since the conventional computer system is provided with only a faulty component detecting function and a hot swap function, it only can automatically detect a faulty component, which therefore must be replaced manually, leading to a disadvantage of a labor intensive job in replacement.

This is because the faulty component must actually be replaced manually, so that if a plurality of components of the same type is used in the computer system, it is difficult for a person in charge of maintenance to find a faulty one of them, leading to a need of employing a dedicated person in charge of maintenance. With the computer conventional system, therefore, a properly operating component may sometimes be replaced mistakenly. Even if an LED is used to indicate the faulty component to the person in charge of maintenance, it takes much of time for him to actually detach and replace it with a new one.

### SUMMARY OF THE INVENTION

In view of the above, it is an object of the present invention to provide a faulty component detecting system which can eliminate the above-mentioned prior art disadvantage by, especially automatically removing a faulty component physically to facilitate and secure its specification and also to simplify a procedure of its replacement.

To achieve above mentioned object, the faulty component detecting system of present invention comprising a board mounted with a plurality of electronic components and a controller for controlling operations of said system itself, wherein: said controller has a faulty-component detecting function to detect a faulty of said electronic components and a hot swap function to control operations of a newly mounted electronic component when any one of said electronic components is detached from said board without turning off a computer which said board is built in; each of said electronic component is mounted on said board with electronic lock means having a key-lock unit which can be unlocked electronically and also has pressing means disposed between said board and said each of said electronic components for pressing said each of said electronic components away from said board; and said controller is provided with a controller-side unlock instructing function to output an unlock instruction to said electronic lock means of any one of said components that is detected to be faulty by said faulty component detecting function.

By a configuration of the present invention, if the controller detects a failure in a predetermined electronic component by its faulty-component detecting function, it uses the controller-side unlock instructing function to output an unlock instruction to the electronic locking means for the faulty component, thus unlocking it. Then, the faulty component thus released is pressed away from the board by the pressing means provided between the board and this component, thus protruding from its normal mounting position. In such a manner, the faulty component is physically removed from the board and slid from its normal mounting position, so that it can be easily specified and replaced with a new one in a less labor intensive manner by a person in charge of maintenance, thus simplifying the procedure for the jobs.

Moreover, a faulty component detecting system according to present invention comprising a board mounted with a plurality of electronic components and a controller for controlling operations of said system itself, wherein: said controller has a faulty-component detecting function to detect a faulty of said electronic components and a hot swap function to control operations of a newly mounted electronic component when any one of said electronic component is detached from said board without turning off a computer which said board is built in; each of said electronic component is mounted on said board with electronic lock means having a key-lock unit which can be unlocked electronically and also has pressing means disposed between said board and said each of said electronic components for pressing said each of said electronic components away from said board; said board is further mounted with a nonvolatile memory which stores a board-side unlock code for unlocking said key-lock unit and said controller is provided with an unlock-code output function to transmit to said electronic lock means said board-side unlock code for any one of said components that is detected to be faulty by said faulty component detecting function; said electronic lock means is provided with an unlock code storage unit for storing a lock means-side unlock code which corresponds to a board-side unlock code for said electronic components and a code comparing unit for comparing to each other a lock means-side unlock code stored in said storage unit and said board-side unlock code; and said code comparing unit is provided with a comparing unit-side unlock instructing function to output an unlock instruction to said key-lock unit if correspondence is detected between said board-side unlock code and said lock means-side unlock code.

By above configuration, if the controller detects a failure in a predetermined electronic component by its faulty component detecting function, it uses the unlock code output function to send a board-side unlock code to the electronic lock means for the faulty component. Then, the code comparing unit of the electronic lock means compares this board-side unlock code to an unlock code of the lock means side and, if correspondence is detected therebetween, the comparing unit uses its comparing unit-side unlock instructing function to output an unlock instruction to the key-lock unit for unlocking. Then, the faulty component thus released from the board is pressed away from the board by the pressing means provided between the board and this component, thus protruding from its normal mounting position. Accordingly, the person in charge of maintenance can easily specify the faulty component to simplify his job procedure. Also, by using the unlock code, it is possible to inhibit such a mistake in unlocking that any other signal causes unlocking.

Moreover, the faulty component detecting system according to present invention, wherein a lock means-side unlock code stored in said unlock-code storage unit of said electronic lock means is specific to each of said plurality of electronic components. Therefore, it is possible to inhibit mistaken unlocking of a normal component, in order to improve the security of removing the faulty components, thus stabilizing a computer in which the present system is installed.

Moreover, the faulty component detecting system according to present invention, wherein said comparing unit-side unlock instructing function of said code comparing unit is activated when agreement is detected between said bard-side unlock code and said lock means-side unlock code. At a result of this, an unlock operation is enabled only when the board-side unlock code and the lock means-side unlock code agree with each other, thus enabling further inhibiting mistaken unlocking.

Moreover, the faulty component detecting system according to present invention, wherein said controller stores in said nonvolatile memory said board-side unlock code containing information of a mounting position of the electronic component newly mounted on said board. By the above configuration, an unlock code containing a mounting position information is stored in a nonvolatile memory beforehand when an electronic component is mounted, so that this information can be referenced before unlocking. Accordingly, the controller can securely output an unlock instruction to a position where a faulty component is mounted to thereby inhibit mistaken unlocking of the electronic components mounted at any other positions, thus improving the system reliability.

Moreover, the faulty component detecting system according to present invention, wherein said pressing means is made of a compression spring. Accordingly, a faulty component, if unlocked, can securely moved away from its normal mounting position, thus further simplifying the construction and reducing the costs.

### BRIEF DESCRIPTION OF THE DRAWINGS

FIG. 1 is a schematic illustration for showing a configuration of one embodiment of the present invention;

FIG. 2 is a block diagram for showing a configuration of electronic lock means of FIG. 1;

FIG. 3 is a flowchart for showing operations of the embodiment of the present invention; and

FIG. 4 is a block diagram for the controller of FIG. 1.

### DESCRIPTION OF THE PREFERRED EMBODIMENTS

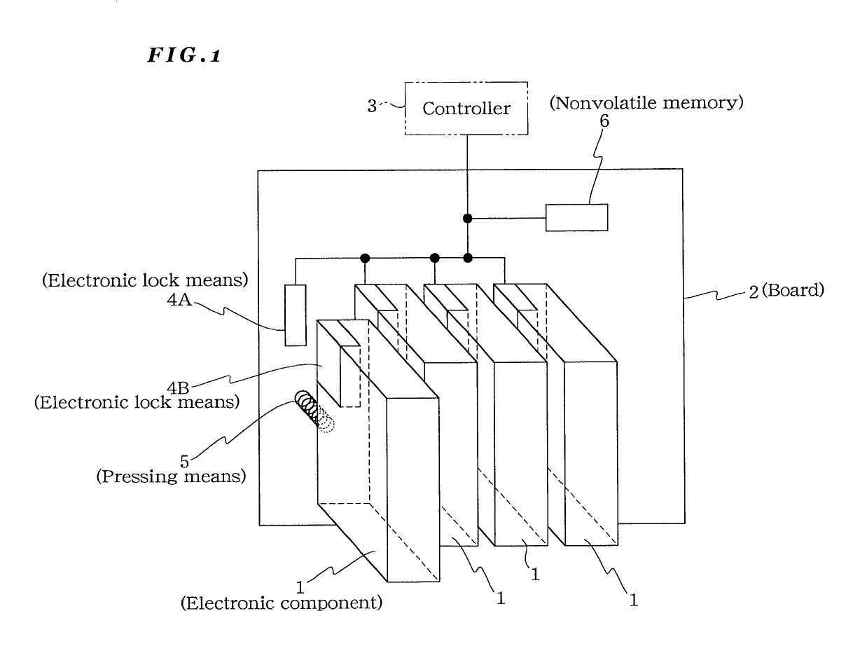

The following will describe one embodiment of the present invention with reference to FIGS. 1-3.

A faulty component detecting system according to the present invention is installed in a large-sized computer mainly such as a server computer required to be of continuous operation. Such a large-sized computer has the hot swap (hot plug) function to enable attaching and detaching of a peripheral device or an electronic component without turning off the power supply. The computer, therefore, can operate continuously because it need not halt the system even if a predetermined component encountered a failure such as a fault.

FIG. 1 is a schematic illustration for showing a configuration of one embodiment of the present invention. A faulty component detecting system according to the present embodiment includes a board 2 on which a plurality of electronic components is mounted and a controller 3 for controlling the operations of the system itself. Although the controller 3 is shown to be of a computer in which the faulty component detecting system of the present invention is installed, the present invention is not limited to this configuration. It may be such a controller for the present system that has a function to execute operations on predetermined information.

Each of the electronic components 1 is mounted to the board 2 with electronic lock means 4A and 4B having key-lock units 4Aa and 4Ba respectively which can be unlocked electronically and also does it have pressing means 5 provided between itself and the board 2 for pressing this electronic component 1 away from this board 2.

Those elements are detailed below.

(Electronic Components)

The plurality of electronic components 1 referred to here may come in an electronic device mounted in an ordinary computer. Specifically, it is a predetermined storage device such as a hard disk or a chip device or component of a memory or a CPU. The electronic components 1 including these are mounted to the board 2 in a computer.

In the computer, each of these electronic components is mounted on the board 2 with respective electronic lock means 4A and 4B. That is, the board 2 and each electronic component 1 have the electronic lock means 4A and 4B respectively, which are engaged with each other. Through those two lock means, the plurality of electronic components 1 is fixed to the board 2 unless the electronic lock is unlocked. The electronic lock means 4A and 4B are described later.

(Board)

The board 2 is specifically a printed-circuit board equipped in the computer. The board 2 is mounted with a variety of electronic components 1 necessary for the operations of the computer. This board further mounted with a nonvolatile memory 6 in which board-side unlock codes for unlocking the key-lock units 4Aa and 4Ba are stored. The nonvolatile memory 6 is a read/write-enabled storage medium with a predetermined storage capacity.

Those board-side unlock codes contain information for identifying each of the electronic components 1 or information for identifying a position at which each of the electronic components 1 is mounted. That is, those codes may contain the information for discriminating between the component types or the information corresponding to the mounting positions on the board 2.

On the board 2, the above-mentioned nonvolatile memory 6 and the board-side electronic lock means 4A corresponding to each of the electronic components 1 are interconnected through printed wiring lines. The above-mentioned controller 3 is connected to both the nonvolatile memory 6 and each of the electronic components through wiring lines which are also printed on the board. The wiring on the board 2, however, is not limited to this.

Further, at such a position on the board 2 that each of the electronic components 1 is mounted, the pressing means 5 is provided as mentioned above. This pressing means 5 is made of a compression spring, so that it stays as compressed state when the electronic component 1 is fixed to the board 2. As described later, therefore, when the electronic lock means 4A and 4B are unlocked to release the electronic component 1 from the board 2, the compression spring presses this released electronic component 1 away from the board 2. As a result, the electronic component 1 thus pressed away by the compression spring moves to a position apart from its normal position on the board 2.

(Controller)

The controller 3, as mentioned above, may be a CPU of the computer in which the present system is installed or any other controller equipped for controlling the operations of the present faulty component detecting system. The controller 3 controls the operations of the electronic components 1 mounted on the board 2, having a faulty-component detecting function of detecting a failure such as a fault of the electronic components 1 and a hot swap function of controlling the operations of a new electronic component 1 mounted in place of a faulty one of the electronic components 1 which has been detached without turning off the power supply of the computer which the board 2 is built in.

This faulty-component detecting function serves to always monitor the operations of the electronic components 1 mounted on the board 2 to thereby detect whether each of these component is operating normally. Also, the hot swap function is generally provided to any computers required to operate continuously and so is omitted in detailed explanation.

The controller 3 further has an unlock-code output function of transmitting to the electronic lock means 4A and 4B a board-side unlock code for any of the components if it is detected to be faulty by the faulty-component detecting function. This unlock-code output function specifically acts to fetch from the above-mentioned nonvolatile memory 6 a board-side unlock code which corresponds to any of the electronic components 1 which is to be unlocked and then transmit this code to the electronic lock means 4A and 4B which fix this component 1 to the board 2.

(Electronic Lock Means)

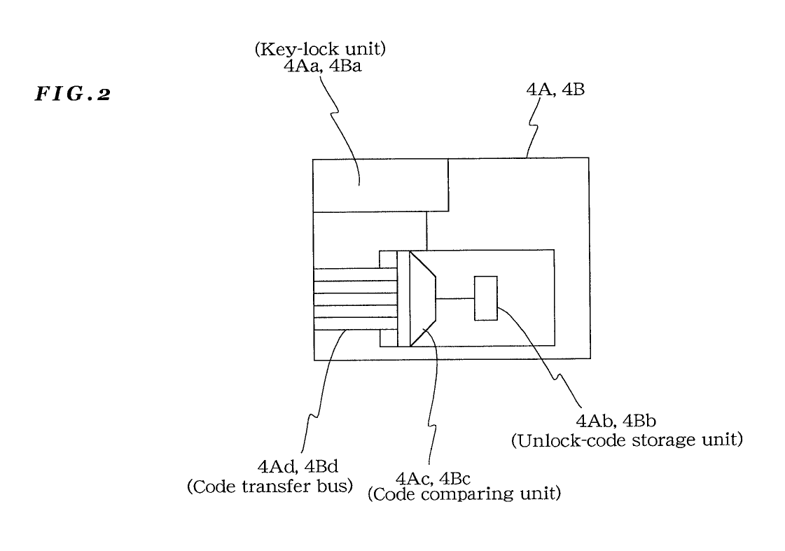

The electronic lock means 4A and 4B are provided in pair on the side of the board 2 and on the side of each of the electronic components 1 respectively, for fixing the electronic component 1 to the board 2. A configuration of the electronic lock means 4A and 4B is shown in FIG. 2.

This pair of the electronic lock means 4A and 4B are equipped with respective key-lock units 4Aa and 4Ba for engaging themselves electrically or mechanically. Those key-lock units 4Aa and 4Ba, however, are unlocked by an electric signal.

One of those paired electronic lock means 4A and 4B, that is, the electronic lock means 4A on the side of the board 2 or the electronic lock means 4B on the side of the electronic component 1 further include unlock-code storage unit 4Ab or 4Bb which store lock means-side unlock code corresponding to board-side unlock codes for the electronic components 1, code comparing unit 4Ac or 4Bc for comparing to each other the lock means-side unlock code stored in the storage unit 4Ab or 4Bb and the board-side unlock codes, and code transfer buses 4Ad and 4Bd for receiving the board-side unlock codes from that controller 3, respectively.

Those code comparing units 4Ac or 4Bc have a comparing unit-side unlock instructing function to output an unlock instruction to the key-lock unit 4Aa or 4Ba if correspondence or agreement is detected between a board-side unlock code and a lock means-side unlock code. When this instruction is transmitted to the key-lock units 4Aa or 4Ba, unlock operation is performed.

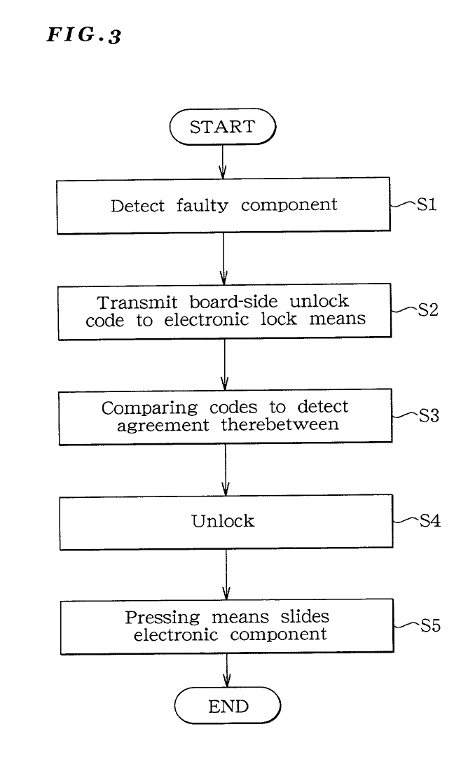

The following will describe the operations of the present embodiment with reference to FIG. 3. FIG. 3 is a flowchart for showing the operations of the present embodiment.

First, the controller 3 uses its faulty component detecting function to detects whether a predetermined electronic component 1 mounted on the board 2 has encountered a failure (step S1). Then, the unlock-code output function is used to fetch from the nonvolatile memory a board-side unlock code which corresponds to thus detected faulty electronic component 1 and then transmit that code to the electronic lock means 4A or 4B which fix this detected electronic component 1 to the board 2 (step S2). Specifically, this code is transmitted to either one of this pair of the electronic lock means 4A and 4B, that is, either one of the board-side and electronic component-side electronic lock means 4A and 4B. Here, it is supposed that the code is sent to the electronic lock means 4B on the side of the electronic component 1. That is, the electronic lock means 4B on the side of this electronic component 1 is provided with an unlock function of the above-mentioned code comparing unit 4Bc etc.

Then, the board-side unlock code transmitted to the electronic lock means 4B is transferred through the code transfer bus 4Bd to the code comparing unit 4Bc. The code comparing unit 4Bc in turn compares this board-side unlock code to a lock means-side unlock code stored in the unlock-code storage unit 4Bb and, if they agree, uses the comparing unit-side unlock instructing function to output an unlock instruction to the key-lock unit 4Ba. This unlock instruction causes the key-lock unit 4Ba to be unlocked.

When its key-lock unit 4Ba is unlocked, the electronic component 1 is released from the board 2 and pressed by the compression spring of the pressing means 5, thus sliding away and apart from the board 2.

Thus, the electronic component 1 can be automatically removed upon detection of its failure, so that it is possible to eliminate a job of its removal in a procedure of replacement by a person in charge of maintenance in order to simplify the processes of failure detection to replacement, thus reducing the working time.

Further, since the faulty component slides away from the board 2 automatically, the person in charge of maintenance can visually confirm a faulty component at a glance, thus facilitating and securing the specification of the faulty component. This results in improvements in reliability of maintenance.

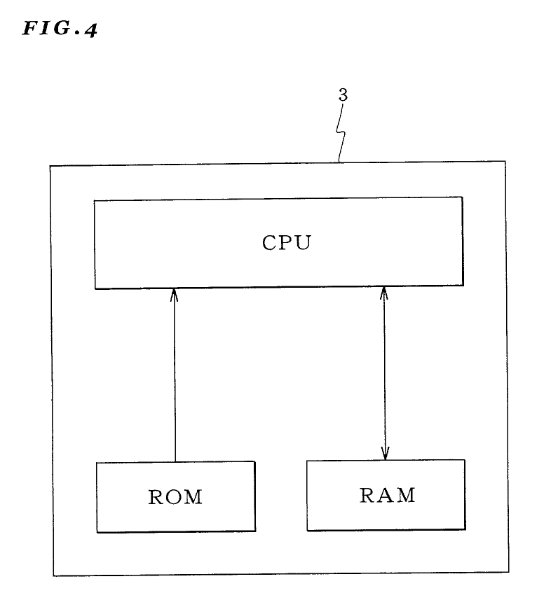

Above operation can be achieved by computer program product stored in computer readable storage medium. Here, for example, FIG. 4 shows the controller 3 including a Central Processing Unit (hereinafter as “CPU”), a Read Only Memroy (hereinafter as “ROM”) and a Random Access Memory (hereinafter as “RAM”). The computer program product is stored in ROM. And the CPU loads the computer program from the ROM, thus the controller 3 can perform above operations.

Although the above embodiment has been described with reference to a case where the code comparing unit 4Bc of the electronic lock means 4B uses its comparing unit-side unlock instructing function to output an unlock instruction to the key-lock unit 4Ba if the comparison-subject codes agree, the present invention is not limited thereto. For example, such a construction example may be employed that the code comparing unit 4Bc may output an unlock instruction to the key-lock unit 4Ba if correspondence is detected between the two comparison-subject codes, specifically, if a total sum of these two codes agrees with a predetermined value. Note here that the case of correspondence of these codes is not limited to this specific example.

Also, the board-side and lock means-side unlock codes are not used so that the controller 3 may instead directly output an unlock instruction to the electronic lock means 4A and 4B, that is, to the key-lock unit 4Aa or 4Ba for unlocking. Therefore, the controller 3 may be provided with the controller-side unlock instructing function to directly instruct unlocking as described above. In this case, it is possible to eliminate the above-mentioned nonvolatile memory 6 and the unlock-code storage unit 4Ab or 4Bb and the code comparing unit 4Ac or 4Bc of the electronic lock means 4A or 4B. As a result, the system can be simplified.

The following will describe another embodiment.

The another embodiment of the present invention has the same basic configuration as the first embodiment described above.

In this another embodiment, the board-side electronic lock means 4A further includes a lock button (not shown) which is pressed by an electronic component 1 when it is mounted. This lock button, when pressed, causes the electronic lock means 4A and 4B to be energized in operation.

Further, a function to recognize the position at which the electronic component 1 is mounted when this lock button is pressed is provided to the above-mentioned controller 3. In addition to this function of recognizing the position of an electronic component 1, the controller 3 is also provided with a function to store in the nonvolatile memory 6 that recognized position in correspondence with a board-side unlock code of that electronic component 1.

In unlocking, therefore, the position of an electronic component 1 stored upon its mounting in the nonvolatile memory 6 by the above-mentioned function is referenced, so that any electronic component 1 mounted at a position different from that of the faulty one can be prevented from being unlocked to thereby improve security of faulty component removal, thus improving the reliability of the present system.

Note here that the above-mentioned lock button may be equipped to the electronic lock means 4B on the side of the electronic component 1. In such a case, when a new replacement component is mounted manually to the electronic lock means 4A, the lock button on this electronic lock means 4B is pressed to cause the electronic lock means 4B to transmit to the controller 3 a lock means-side unlock code stored in the unlock-code storage unit 4Bb. Thus, such a function is provided to the electronic lock means 4B. The controller 3, however, may be provided with a function to automatically read information of a new component. In this case, when receiving that unlock code, the controller 3 compares it to a board-side unlock code stored in the nonvolatile memory 6, thus confirming the mounting position.

Thus, this embodiment also can have almost the same effects as the first embodiment, to improve security of specifying a faulty component to be removed, thus improving the reliability of the present system.

In this embodiment, the lock button is not limited to a button shaped one for recognizing, when pressed, the mounting of the electronic component 1. For example, it may be of a lever shape or may be any other electronic means as far as it can detect the mounting of the electronic component 1.

In the above-mentioned functional configuration of the invention, if a failure is detected in a predetermined electronic component, a board-side unlock code is transmitted to electronic lock means of this detected faulty component, which electronic lock means in turn compares this board-side unlock code to a lock means-side unlock code, so that if correspondence is detected between these two codes, the faulty component is unlocked and released from the board and then pressed away and slid therefrom by pressing means to be easily and securely specified by a person in charge of maintenance etc., thus giving an excellent effect of a simplified procedure of removing faulty components over the prior art technologies.

Also, use of the unlock code enables preventing mistaken unlocking by any other signals, thus improving the system reliability.

The invention may be embodied in other specific forms without departing from the spirit or essential characteristic thereof.

The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-355259 (Filed on Nov. 22, 2000) including specification, claims, drawings and summary are incorporated herein by reference in its entirety.

What is claimed is:

1. A faulty component detecting system comprising a board mounted with a plurality of electronic components and a controller for controlling operations of said system itself, wherein:
said controller has a faulty-component detecting function to detect a faulty of said electronic components and a hot swap function to control operations of a newly mounted electronic component when any one of said electronic components is detached from said board without turning off a computer which said board is built in;
each of said electronic component is mounted on said board with electronic lock means having a key-lock unit which can be unlocked electronically and also has pressing means disposed between said board and said each of said electronic components for pressing said each of said electronic components away from said board; and
said controller is provided with a controller-side unlock instructing function to output an unlock instruction to said electronic lock means of any one of said components that is detected to be faulty by said faulty component detecting function.

2. A faulty component detecting system comprising a board mounted with a plurality of electronic components and a controller for controlling operations of said system itself, wherein:
said controller has a faulty-component detecting function to detect a faulty of said electronic components and a hot swap function to control operations of a newly mounted electronic component when any one of said electronic component is detached from said board without turning off a computer which said board is built in;
each of said electronic component is mounted on said board with electronic lock means having a key-lock unit which can be unlocked electronically and also has pressing means disposed between said board and said each of said electronic components for pressing said each of said electronic components away from said board;
said board is further mounted with a nonvolatile memory which stores a board-side unlock code for unlocking said key-lock unit and said controller is provided with an unlock-code output function to transmit to said electronic lock means said board-side unlock code for any one of said components that is detected to be faulty by said faulty component detecting function;
said electronic lock means is provided with an unlock code storage unit for storing a lock means-side unlock code which corresponds to a board-side unlock code for said electronic components and a code comparing unit for comparing to each other a lock means-side unlock code stored in said storage unit and said board-side unlock code; and
said code comparing unit is provided with a comparing unit-side unlock instructing function to output an unlock instruction to said key-lock unit if correspondence is detected between said board-side unlock code and said lock means-side unlock code.

3. The faulty component detecting system according to claim 2, wherein a lock means-side unlock code stored in said unlock-code storage unit of said electronic lock means is specific to each of said plurality of electronic components.

4. The faulty component detecting system according to claim 2, wherein said comparing unit-side unlock instructing function of said code comparing unit is activated when agreement is detected between said bard-side unlock code and said lock means-side unlock code.

5. The faulty component detecting system according to claim 3, wherein said comparing unit-side unlock instructing function of said code comparing unit is activated when agreement is detected between said bard-side unlock code and said lock means-side unlock code.

6. The faulty component detecting system according to claim 2, wherein said controller stores in said nonvolatile memory said board-side unlock code containing information of a mounting position of an electronic component newly mounted on said board.

7. The faulty component detecting system according to claim 3, wherein said controller stores in said nonvolatile memory said board-side unlock code containing information of a mounting position of an electronic component newly mounted on said board.

8. The faulty component detecting system according to claim 4, wherein said controller stores in said nonvolatile memory said board-side unlock code containing information of a mounting position of an electronic component newly mounted on said board.

9. The faulty component detecting system according to claim 1, wherein said pressing means is made of a compression spring.

10. The faulty component detecting system according to claim 2, wherein said pressing means is made of a compression spring.

11. Computer program product used for faulty component detecting system stored in computer readable storage medium, wherein the system including a board mounted with a plurality of electronic components and a controller for controlling operations of said system itself: the computer program product comprising process of:
detecting the faulty component,
transmitting a board side unlock code to an electronic lock means,
comparing the board side lock code to a lock means side unlock code, and
unlocking the lock means if those code agree each other.
